(19) United States
(12) Patent Application Publication
(10) Pub. No.: US 2026/0307084 A1
(43) Pub. Date: Oct. 8, 2026

(54) MULTI-CYCLONIC SEPARATOR ASSEMBLY

(71) Applicant: FMC Separation Systems B.V., Arnhem (NL)

(72) Inventors: Sander Guido Baaren, The Hague (NL); Gijsbert Menno Graafland, Didam (NL)

(21) Appl. No.: 19/173,457

(22) Filed: Apr. 8, 2025

(51) Int. Cl. B04C 3/04; B04C 3/06; B04C 3/00

(52) U.S. Cl. CPC B04C 3/04; B04C 3/06; B04C 2003/006

(57) ABSTRACT

A multi-cyclonic separator assembly may include a plurality of cyclonic separators. Each cyclonic separator of the plurality of cyclonic separators may comprise an inlet configured to receive an input stream comprising a heavy fluid and a light fluid. Each cyclonic separator may further comprise a separation chamber in fluid communication with the inlet. The separation chamber may comprise a swirl element configured for at least partially separating the heavy fluid from the light fluid, a light fluid chamber inlet configured to receive the separated light fluid, and a heavy fluid chamber inlet configured to receive the separated heavy fluid. The multi-cyclonic separator assembly may further include a light fluid chamber in fluid communication with each light fluid chamber inlet and a heavy fluid chamber in fluid communication with each heavy fluid chamber inlet. In some embodiments, a separator assembly may include a single cyclonic separator.

### BACKGROUND

### 1. FIELD

Embodiments of the present disclosure relate to cyclone separators used for separating liquids and gases with varying densities.

### 2. RELATED ART

Cyclone separators are widely used to separate particles from gas streams, liquid from gas, or different liquids with varying densities. For separation to occur, cyclones rely on centrifugal forces to push the heavier (e.g., denser) particles of an input stream toward the walls of the cyclone while allowing the lighter particles to remain closer to the center of the cyclone and exit through a designated outlet. For example, to separate a liquid from a gas stream, a cyclone relies on centrifugal forces to induce (e.g., promote or facilitate) a swirling flow that pushes the denser liquid toward the walls of the cyclone while allowing the lighter gas to remain closer to the center of the swirling flow to exit through a designated gas outlet. As the lighter particles move through the cyclone, a low-pressure region forms at the center of the cyclone due to the swirling flow. The swirling flow induces a pressure gradient to guide the gas toward the designated gas outlet while the separated liquid moves along the walls of the cyclone toward a designated liquid outlet. While cyclones are effective in many applications, they face various challenges that impact the efficiency and reliability of the cyclone. These challenges include the presence of an input stream where the interfacial tension between the liquid and gas is low, the need to balance the velocity of the swirling flow without causing excessive liquid re-entrainment, and limitations on how much liquid the cyclone can handle.

One issue arises when the interfacial tension between the liquid and gas is low, which results in smaller liquid droplets within the swirling flow. Smaller liquid droplets are more susceptible to drag forces from gas flow, making them more likely to remain closer to the center of the swirling flow and reach the gas outlet rather than joining the larger liquid droplets being flung to the walls of the cyclone for separation. The small liquid droplets that do end up reaching the walls of the cyclone form a liquid film. However, when the interfacial tension is low between the liquid and gas, and the velocity of the swirling flow is high, the liquid film can become unstable and break into small liquid droplets, leading to re-entrainment into the center of the swirling flow and reducing separation efficiency of the cyclone.

Another challenge involves balancing the velocity of the swirling flow within the cyclone to maximize centrifugal separation while avoiding excessive liquid re-entrainment. A swirling flow with a greater velocity can improve the separation efficiency of the cyclone by increasing centrifugal forces, allowing smaller liquid droplets to be removed from the swirling flow and flung to the walls of the cyclone to form the liquid film. However, at excessive swirling flow speeds, the liquid film along the cyclone walls can become unstable, causing liquid droplets to be stripped from the liquid film and reintroduced into the center of the swirling flow. This problem is evident in both vertical and horizontal cyclone separators, where excessive swirl velocities lead to liquid re-entrainment, while lower swirl velocities may result in inadequate separation of small liquid droplets.

Additionally, cyclones are limited in the amount of liquid they can effectively handle. In some designs, such as vertical downflow cyclone separators, separated liquid typically must drain into a designated liquid reservoir. However, if the liquid inflow exceeds the drainage capacity, liquid can accumulate and be drawn back into the flow of the input stream. Horizontal inline cyclone separators improve upon this by incorporating a re-cycling mechanism to assist in liquid drainage, allowing the horizontal cyclone to handle higher liquid loads. However, in a horizontal cyclone, the liquid film must travel along the walls of the cyclone in a helical flow pattern, around a horizontal axis of the cyclone, toward a liquid drain outlet. Thus, if there is an insufficient swirling flow velocity within the horizontal cyclone to help push the liquid film against the wall, the liquid film will increase in thickness and eventually collapse with the help of gravity into droplets that re-enter the center of the swirling flow. This causes the liquid droplets to enter the gas outlet, and the separation efficiency collapses. Vertical cyclones have improved with similar re-cycle mechanisms, but as more liquid enters the designated liquid reservoir of the vertical cyclone, the liquid from the reservoir is more easily sucked into the re-cycle mechanism and back into the swirling flow. Accordingly, in view of these limitations, there is a need to develop a solution that increases the separation efficiency of cyclones.

### SUMMARY

Embodiments of the present disclosure solve the above-mentioned problems by providing a cyclonic separator assembly including a plurality of vertical-downflow cyclone separators.

An embodiment of the current disclosure comprises a cyclonic separator. The cyclonic separator may include an inlet configured to receive an input stream, wherein the input stream includes a heavy fluid and a light fluid. The cyclonic separator may further include a separation chamber in fluid communication with the inlet. The separation chamber may include a swirl element configured to induce a downward rotating flow of the input stream inside the separation chamber such that centrifugal forces are generated to at least partially separate the heavy fluid from the light fluid, a light fluid chamber inlet configured to receive the separated light fluid, and a heavy fluid chamber inlet configured to receive the separated heavy fluid. The cyclonic separator may further include a light fluid chamber in fluid communication with the light fluid chamber inlet of the separation chamber, wherein the light fluid chamber is configured to receive the separated light fluid from the separation chamber. The cyclonic separator may further include a heavy fluid chamber in fluid communication with the heavy fluid chamber inlet of the separation chamber, wherein the heavy fluid chamber is configured to receive the separated heavy fluid from the separation chamber. The cyclonic separator may further include a heavy fluid chamber outlet in fluid communication with the heavy fluid chamber, wherein the heavy fluid chamber outlet is configured to receive the separated heavy fluid from the heavy fluid chamber.

An embodiment of the current disclosure comprises a multi-cyclonic separator assembly that may include a plurality of cyclonic separators, wherein each cyclonic separator of the plurality of cyclonic separators may include at least one tangential inlet configured to receive an input stream, wherein the input stream includes a heavy fluid and a light fluid. Each cyclonic separator may further include a separation chamber in fluid communication with the at least one tangential inlet, wherein the at least one tangential inlet is further configured to induce a downward rotating flow of the input stream inside the separation chamber such that centrifugal forces are generated to at least partially separate the heavy fluid from the light fluid. The separation chamber may include a light fluid chamber inlet configured to receive the separated light fluid, and a heavy fluid chamber inlet configured to receive the separated heavy fluid. The multi-cyclonic separator assembly may further include a light fluid chamber in fluid communication with each light fluid chamber inlet of the plurality of cyclonic separators, wherein the light fluid chamber is configured to receive the separated light fluid from each cyclonic separator of the plurality of cyclonic separators. The multi-cyclonic separator assembly may further include a heavy fluid chamber in fluid communication with each heavy fluid chamber inlet of the plurality of cyclonic separators, wherein the heavy fluid chamber is configured to receive the separated heavy fluid from each cyclonic separator of the plurality of cyclonic separators. The multi-cyclonic separator assembly may further include a heavy fluid chamber outlet in fluid communication with the heavy fluid chamber, wherein the heavy fluid chamber outlet is configured to receive the separated heavy fluid from the heavy fluid chamber.

In some embodiments, the techniques described herein relate to a system of multi-cyclonic separator assemblies that may include a plurality of multi-cyclonic separator assemblies, wherein each multi-cyclonic separator assembly of the plurality of multi-cyclonic separator assemblies may include a plurality of cyclonic separators. Each cyclonic separator of the plurality of cyclonic separators may include a swirl element configured to receive an input stream, wherein the input stream includes a heavy fluid and a light fluid. Each cyclonic separator of the plurality of cyclonic separators may further include a separation chamber in fluid communication with the swirl element, wherein the swirl element is further configured to induce a downward rotating flow of the input stream inside the separation chamber such that centrifugal forces are generated to at least partially separate the heavy fluid from the light fluid. The separation chamber may include a light fluid chamber inlet configured to receive the separated light fluid, and a heavy fluid chamber inlet configured to receive the separated heavy fluid. The system of multi-cyclonic separator assemblies may further include a light fluid chamber in fluid communication with each light fluid chamber inlet of the plurality of cyclonic separators, wherein the light fluid chamber is configured to receive the separated light fluid from each cyclonic separator of the plurality of cyclonic separators. The system of multi-cyclonic separator assemblies may further include a heavy fluid chamber in fluid communication with each heavy fluid chamber inlet of the plurality of cyclonic separators, wherein the heavy fluid chamber is configured to receive the separated heavy fluid from each cyclonic separator of the plurality of cyclonic separators. The system of multi-cyclonic separator assemblies may further include a heavy fluid chamber outlet in fluid communication with the heavy fluid chamber, wherein the heavy fluid chamber outlet is configured to receive the separated heavy fluid from the heavy fluid chamber.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 illustrates a cross-sectional view of an exemplary multi-cyclonic separator assembly in accordance with embodiments disclosed herein;

FIG. 2 illustrates a cross-sectional view of an exemplary multi-cyclonic separator assembly in accordance with embodiments disclosed herein;

FIG. 3A illustrates a three-dimensional cutaway view of an exemplary multi-cyclonic separator assembly in accordance with embodiments disclosed herein;

FIG. 3B illustrates a three-dimensional cutaway view of a bottom portion of a multi-cyclonic separator assembly in accordance with embodiments disclosed herein;

FIG. 3C illustrates a three-dimensional cutaway view of a multi-cyclonic separator assembly in accordance with embodiments disclosed herein;

FIG. 4A illustrates an exemplary system of multi-cyclonic separator assemblies in accordance with embodiments disclosed herein;

FIG. 4B illustrates an exemplary system of multi-cyclonic separator assemblies in accordance with embodiments disclosed herein;

FIG. 4C illustrates an exemplary system of multi-cyclonic separator assemblies in accordance with embodiments disclosed herein; and

FIG. 5 illustrates an exemplary multi-cyclonic separator assembly configuration in accordance with embodiments disclosed herein.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments herein describe a cyclone separator assembly including a plurality of cyclone separators. For example, the plurality of cyclone separators may be a plurality of vertical-downflow cyclone separators. In some embodiments, the plurality of cyclone separators may also comprise a re-cycle system. Using multiple cyclone separators in a single assembly advantageously allows for achieving the same throughput input stream (of a gas and/or liquid) capacity as a single, large cyclone separator. Additionally, because the circumferences of the plurality of cyclone separators may be designed to be smaller than the circumference of the single, large cyclone separator, more centrifugal forces may be generated for the same, or even lower, input stream velocity used by the large cyclone separator. For instance, an input stream spinning around in a separation chamber with a smaller circumference may generate more centrifugal forces than the larger cyclone separator. Therefore, the plurality of cyclone separators can more efficiently separate an input stream by using lower input stream velocities to further avoid excessive liquid re-entrainment, while also maximizing fluid capacity. This results in a cyclone separator assembly configuration that enables a higher separation efficiency, even for input streams with low interfacial tensions, than the configuration of the large cyclone separator.

In some embodiments, the cyclone separator assembly may comprise cyclone separators with varying circumferences. For example, a cyclone separator of the cyclone separator assembly may have a diameter ranging from 1 inch to 50 inches. In some embodiments, the circumference of the cyclone separator may be dependent on a separation efficiency target of the cyclone separator assembly. For example, where a lower separation efficiency target is acceptable, a cyclone separator may have a diameter ranging from 10 inches to 48 inches. In contrast, if a higher separation efficiency is required for the cyclone separator assembly, the cyclone separator may have a smaller diameter ranging from 2 inches to 6 inches. It is noted that these are non-limiting examples, and the cyclone separator may have any diameter or circumference in accordance with the embodiments disclosed herein for achieving a separation of a heavy and light fluid.

Further, multiple cyclone separator assemblies may be put into a system to aggregate the advantages achieved by a single cyclone separator assembly described herein. In some embodiments, the cyclone separator assembly includes a single cyclone separator in accordance with embodiments described herein.

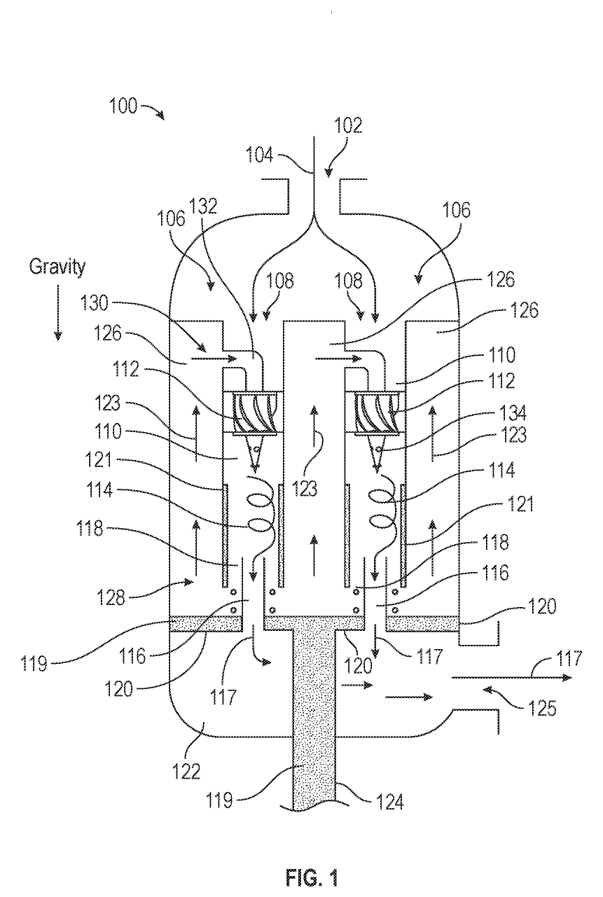

FIG. 1 illustrates a cross-sectional view of an exemplary multi-cyclonic separator assembly 100 in accordance with embodiments disclosed herein. Assembly 100 may include a plurality of cyclonic separators 106. Each cyclonic separator 106 may receive an input stream 104 comprising a light fluid and a heavy fluid. The terms “heavy fluid” and “light fluid” referenced herein may refer to a gas or a liquid. For example, input stream 104 may include a heavy fluid (e.g., gas or liquid) and a light fluid (e.g., gas or liquid), where the heavy fluid has a greater density than the light fluid. For instance, the light fluid may be natural gas while the heavy fluid may be crude oil. In another example, the light fluid may be dense phase carbon dioxide while the heavy fluid may be water.

Cyclonic separators 106 may include a separation chamber 110. Cyclonic separators 106 may be configured to at least partially separate the light fluid from the heavy fluid within separation chamber 110. Cyclonic separators 106 may further include a light fluid chamber inlet 116 configured to receive separated light fluid 117. Cyclonic separators 106 may further include a heavy fluid chamber inlet 118 configured to receive separated heavy fluid 119. Assembly 100 may further comprise a light fluid chamber 122, a heavy fluid chamber 120, and a heavy fluid chamber outlet 124. Light fluid chamber 122 may be configured to receive separated light fluid 117 from each cyclonic separator 106. In contrast, heavy fluid chamber 120 may be configured to receive separated heavy fluid 119 from each cyclonic separator 106. In some embodiments, heavy fluid chamber outlet 124 is configured to receive separated heavy fluid 119 from heavy fluid chamber 120.

In some embodiments, assembly 100 may further include a re-cycle system. The re-cycle system may comprise a re-cycle chamber 126 in fluid communication with heavy fluid chamber 120 and at least one separation chamber 110 of the plurality of cyclonic separators 106. Re-cycle chamber 126 may be configured to route a re-cycled portion of light fluid 123 from heavy fluid chamber 120 to the at least one separation chamber 110. For example, re-cycled portion of light fluid 123 may be a portion of the light fluid of input stream 104 which has not yet been received by light fluid chamber inlet 116 of each cyclonic separator 106 of assembly 100.

In some embodiments, assembly 100 includes an assembly inlet 102 configured to receive input stream 104. Input stream 104 may then enter cyclonic separators 106 through separator inlets 108. Each cyclonic separator 106 may include a separator inlet 108 in fluid communication with separation chamber 110.

Assembly 100 may include any number of cyclonic separators 106. For instance, assembly 100 may house a single cyclonic separator 106. In another example, assembly 100 may house more than one cyclonic separator 106. In some embodiments, cyclonic separators 106 may be configured as vertical downflow cyclonic separators in parallel. In some embodiments, assembly 100 may be a housing, such as a pressure vessel, where cyclonic separators 106 are disposed within the pressure vessel.

Each of the cyclonic separators 106 may further comprise separator inlet 108 configured to receive the input stream 104 from assembly inlet 102. In some embodiments, assembly inlet 102 may be located at a top, side, or bottom portion of assembly 100. Separator inlet 108 may be any opening allowing input stream 104 to be in fluid communication with separation chamber 110 such that input stream 104 may enter separation chamber 110 during operative conditions. For example, separator inlet 108 may be a single opening or a plurality of openings (e.g., perforated) in a wall portion of separation chamber 110. In another example, separator inlet 108 may be a top or side slot of separation chamber 110. Separation chamber 110 may be a tube, channel, or any other structure configured for directing the flow of input stream 104 in accordance with embodiments disclosed herein. In some embodiments, separation chamber 110 may be fully or partially enclosed. For example, separation chamber 110 may include outer walls that partially or fully enclose an inner region of separation chamber 110.

In some embodiments, cyclonic separators 106 further include a swirl element 112. For example, separation chamber 110 may include swirl element 112. Swirl element 112 is configured to generate centrifugal forces that induce a downward rotating flow 114 of input stream 104 inside separation chamber 110. The generated centrifugal forces within separation chamber 110 may at least partially separate the light fluid of input stream 104 from the heavy fluid of input stream 104. For example, the generated centrifugal forces of downward rotating flow 114 may impose a force on and push particles (e.g., droplets) of the heavy fluid towards an outer perimeter of separation chamber 110 to prevent at least a portion of the heavy fluid from going into light fluid chamber inlet 116. For example, the heavy fluid may be separated and pushed towards or against the perimeter of an inner wall of separation chamber 110. As the heavy fluid contacts (e.g., hits) the inner wall of separation chamber 110, a liquid film 121 may be formed on the inner wall. Liquid film 121, which may contain a portion of the heavy fluid, may then be pushed along the inner wall towards heavy fluid chamber inlet 118. For example, the heavy fluid may be pushed by gravity to heavy fluid chamber inlet 118 for separation. In some embodiments, the inner walls of separation chamber 110 may include vanes or indentions to help guide the heavy fluid contained in liquid film 121 towards heavy fluid chamber inlet 118. Heavy fluid chamber inlet 118 may be in fluid communication with heavy fluid chamber 120. The heavy fluid becomes separated heavy fluid 119 upon entering heavy fluid chamber inlet 118. Separated heavy fluid 119 may then be received by heavy fluid chamber 120 via heavy fluid chamber inlet 118.

In contrast, particles (e.g., bubbles) of the light fluid contained within input stream 104, which may not be dense enough to be pushed or flung to the inner wall of separation chamber 110 by the generated centrifugal forces of downward rotating flow 114, may be pushed towards a center axis of downward rotating flow 114 (e.g., center axis of separation chamber 110) such that particles of the light fluid may enter light fluid chamber inlet 116. The light fluid becomes separated light fluid 117 upon entering light fluid chamber inlet 116. For example, downward rotating flow 114 may include a central flow configured to direct at least a portion of the light fluid into light fluid chamber inlet 116. The central flow may be formed by at least a pressure gradient generated by swirl element 112, where the pressure within the central flow is lower than the pressure near the inner walls of separation chamber 110. Light fluid chamber inlet 116 may be in fluid communication with light fluid chamber 122. Separated light fluid 117 may then be received by light fluid chamber 122 via light fluid chamber inlet 116.

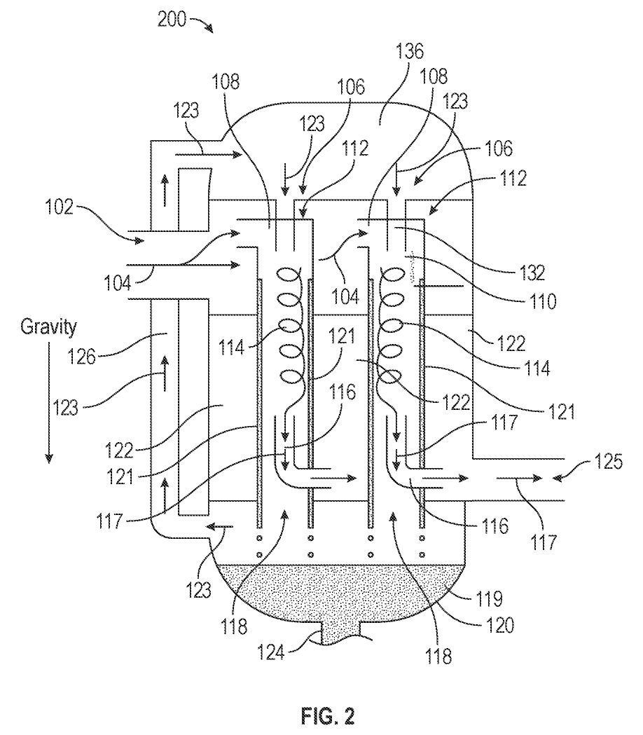

Downward rotating flow 114 may be downstream (e.g., below) swirl element 112. Downward rotating flow 114 is configured to at least partially separate the light fluid of input stream 104 from the heavy fluid of input stream 104. Swirl element 112 may be a fluid rotation device, a tangential inlet (further discussed below in reference to FIG. 2), or any other device or component now known or later developed for promoting centrifugal separation and inducing downward rotating flow 114 in accordance with embodiments disclosed herein.

In some embodiments, swirl element 112 may be a fluid rotation device (as depicted in FIG. 1) that is fan-like with blades. The fan-like structure may include a plurality of blades or vanes positioned at an angle relative to the flow path of input stream 104 to induce rotational motion within separation chamber 110. The blades may be fixed or adjustable, allowing for control over the flow velocity of downward rotating flow 114. In some embodiments, the fan-like structure may be integrated within the tangential inlet or positioned within separation chamber 110 for efficient phase separation of input stream 104.

In yet another embodiment, swirl element 112 may include a pipe extending from a perimeter location of separation chamber 110 to a central region of separation chamber 110. This pipe configuration may extract, inject, or redistribute a portion of input stream 104 or an additional fluid within the downward rotating flow 114. In some embodiments, swirl element 112 may comprise hollow blades fluidly connected to swirl element 112. The internal passages within the hollow blades may be designed to introduce fluid into downward rotating flow 114.

These various embodiments of swirl element 112 may be implemented individually or in combination to achieve optimized separation performance by cyclonic separators 106. The structural configurations described herein may be adapted based on application-specific requirements, including variations in flow velocities, fluid properties, or separation efficiency targets.

In some embodiments, light fluid chamber inlet 116 may be an opening configured to receive separated light fluid 117 from separation chamber 110. In some embodiments, light fluid chamber inlet 116 may be a chamber, tube, channel, or other suitable structure configured to receive and direct separated light fluid 117 in accordance with embodiments disclosed herein. Light fluid chamber inlet 116 may be positioned along a wall of separation chamber 110 to direct separated light fluid 117 away from the separation region within separation chamber 110. In some embodiments, light fluid chamber inlet 116 may be in a central or substantially central region within separation chamber 110 such that particles of the light fluid may enter light fluid chamber inlet 116 for separation. Light fluid chamber inlet 116 may be in fluid communication with light fluid chamber 122. In some embodiments, light fluid chamber inlet 116 may include vanes or indentions to help guide separated light fluid 117 towards light fluid chamber 122.

In some embodiments, heavy fluid chamber inlet 118 may be an opening configured to receive separated heavy fluid 119 from separation chamber 110. In other embodiments, heavy fluid chamber inlet 118 may be a chamber, tube, channel, slot or any other suitable structure configured to receive and direct separated heavy fluid 119 in accordance with embodiments disclosed herein. In some embodiments, heavy fluid chamber inlet 118 may be located near an inner wall of separation chamber 110. In other embodiments, heavy fluid chamber inlet 118 may be located below light fluid chamber inlet 116.

In some embodiments, each cyclonic separator 106 may have a respective light fluid chamber inlet 116 and/or heavy fluid chamber inlet 118 in fluid communication with a respective light fluid chamber 122 and/or heavy fluid chamber 120. Any separated light fluid 117 or separated heavy fluid 119 received by light fluid chamber inlet 116 and heavy fluid chamber inlet 118 may enter a respective light fluid chamber 122 and/or heavy fluid chamber 120. For example, cyclonic separators 106 may each include light fluid chamber inlet 116, where separated light fluid 117 received by each light fluid chamber inlet 116 may then enter light fluid chamber 122. In another example, cyclonic separators 106 may each include heavy fluid chamber inlet 118, where separated heavy fluid 119 received by each heavy fluid chamber inlet 118 may then enter heavy fluid chamber 120. In other embodiments, assembly 100 may include a single light fluid chamber 122 and/or a single heavy fluid chamber 120 for each cyclonic separator 106. In some embodiments, assembly 100 may only include a single light fluid chamber 122 and/or a single heavy fluid chamber 120 in fluid communication with every cyclonic separator 106 of assembly 100.

Further, assembly 100 may include heavy fluid chamber outlet 124, where any separated heavy fluid 119 received by heavy fluid chamber 120 may enter heavy fluid chamber outlet 124. For example, heavy fluid chamber 120 may be in fluid communication with heavy fluid chamber outlet 124. In some embodiments, each cyclonic separator 106 may include a heavy fluid chamber outlet 124 in fluid communication with a respective heavy fluid chamber inlet 118. In some embodiments, heavy fluid chamber outlet 124 may be a channel, drain, chamber, or tube through which separated heavy fluid 119 may leave assembly 100.

Additionally, assembly 100 may include light fluid chamber outlet 125, where any separated light fluid 117 received by light fluid chamber 122 may enter light fluid chamber outlet 125 for external disposition. Light fluid chamber outlet 125 may be a channel, drain, chamber, or tube through which separated light fluid 117 may leave assembly 100. In some embodiments, light fluid chamber outlet 125 or light fluid chamber inlet 116 may be in fluid communication with downstream processing or discharge systems. In other embodiments, each cyclonic separator 106 may include a heavy fluid chamber outlet 124 in fluid communication with a respective heavy fluid chamber inlet 118.

In some embodiments, at least one of the cyclonic separators 106 of assembly 100 may include the re-cycle system. The re-cycle systems contained in assembly 100 may be used to increase separation efficiency of each cyclonic separator 106 by directing a flow of any portions of the light fluid contained in heavy fluid chamber 120 to re-enter separation chamber 110 for further separation. The re-cycle system may include re-cycle chamber 126 configured to route re-cycled portion of light fluid 123 from heavy fluid chamber 120 to separation chamber 110. For example, as input stream 104 is separated in separation chamber 110, portions of the light fluid may already be separated from the heavy fluid but may not enter light fluid chamber inlet 116. For instance, a portion of the light fluid of input stream 104 within separation chamber 110 may miss (e.g., go around) the light fluid chamber inlet 116 as the light fluid travels with downward rotating flow 114 toward light fluid chamber inlet 116. Portions of the light fluid that miss the light fluid chamber inlet 116 may enter heavy fluid chamber 120 and be referred to herein as a re-cycled portion of light fluid 123. The re-cycled portion of light fluid 123 contained in heavy fluid chamber 120 may then re-enter separation chamber 110 via re-cycle chamber 126 for further separation.

In another example, as the light fluid travels through separation chamber 110, portions of the light fluid may not yet be fully separated from the heavy fluid and may thus be flung towards the inner walls of separation chamber 110 and subsequently enter heavy fluid chamber 120 along with heavy fluid particles. Re-cycled portion of light fluid 123 not yet separated and now located in heavy fluid chamber 120 may re-enter separation chamber 110 via re-cycle chamber 126 for further separation. In some embodiments, re-cycled portion of light fluid 123 re-enters separation chamber 110 via re-cycle chamber 126 as many times as necessary so that re-cycled portion of light fluid 123 is eventually separated by (enters) light fluid chamber inlet 116. In some embodiments, the re-cycle system operates passively (e.g., passive flow) based on various pressure gradients within assembly 100.

The re-cycle system may include a re-cycle chamber 126 comprising a re-cycle chamber inlet 128 and a re-cycle chamber outlet 130. Re-cycle chamber 126 of each cyclonic separator 106 may be in fluid communication with heavy fluid chamber 120 via re-cycle chamber inlet 128. Further, re-cycle chamber 126 may be in fluid communication with separation chamber 110 via re-cycle chamber outlet 130. As discussed above, re-cycle chamber 126 may be configured to receive re-cycled portion of light fluid 123 contained in heavy fluid chamber 120, which has not yet been received by light fluid chamber inlet 116 of at least one cyclonic separator 106.

Re-cycled portion of light fluid 123 may enter re-cycle chamber 126 via re-cycle chamber inlet 128 and subsequently re-enter separation chamber 110 of the respective cyclonic separator 106 via re-cycle chamber outlet 130. In some embodiments, re-cycle chamber outlet 130 may be a re-cycle outlet channel 132 in fluid communication with separation chamber 110. In some embodiments, re-cycle outlet channel 132 may be a tube coupled to swirl element 112. For example, swirl element 112 may be a fluid rotation device comprising at least one fluid rotation device opening 134 in fluid communication with the re-cycle outlet channel 132. Re-cycled portion of light fluid 123 routed into re-cycle chamber 126 may enter separation chamber 110 via the re-cycle outlet channel 132 and fluid rotation device opening 134. Fluid rotation device opening 134 may be positioned within or near the same central region of separation chamber 110 as downward rotating flow 114. Thus, re-cycled portion of light fluid 123 that re-enters separation chamber 110 may enter the central flow of downward rotating flow 114 and be directed towards light fluid chamber inlet 116. Additionally, a pressure gradient may be induced by re-cycled portion of light fluid 123 re-entering separation chamber 110 via fluid rotation device opening 134, where the pressure gradient may further assist in pushing the heavy liquid particles contained within liquid film 121 towards heavy fluid chamber inlet 118.

In some embodiments, cyclonic separator 106 may be held in place using tube sheets. For example, cyclonic separators 106 may be vertical downflow cyclonic separators 106 mounted in the holes of the tube sheets, such that the tube sheets accommodate at least separator inlet 108, the re-cycle system, heavy fluid chamber 120, and light fluid chamber 122. In some embodiments, the tube sheets may enclose (e.g., seal) an entire or partial cross-sectional area of assembly 100 such that any separated heavy fluid 119 may pool on the tube sheets and enter a shared heavy fluid chamber outlet 124 (e.g., a shared central drain), while any re-cycled portions of the light fluid 123 may re-enter separation chamber 110 via the re-cycle system of a respective cyclonic separator 106.

In some embodiments, multi-cyclonic separator assembly 100 comprises two or more separation stages, which may be vertically displaced relative to one another. For example, a first separation stage may include one or more primary cyclonic separators 106. For instance, one or more primary cyclonic separators 106 may be horizontally displaced from one another within assembly 100. Separation chambers 110 of primary cyclonic separators 106 may each receive input stream 104 from a primary separator inlet 108 and separate the heavy fluid from the light fluid. Separated heavy fluid 119 of the first separation stage may be received by a primary heavy fluid chamber inlet 118 of each of the primary cyclonic separators 106. Separated heavy fluid 119 may then be subsequently routed to a primary heavy fluid chamber 120 in fluid communication with each of the primary heavy fluid chamber inlets 118. In some embodiments, separated heavy fluid 119 may then be routed to a primary heavy fluid chamber outlet 124.

Separated light fluid 117 of the first separation stage may be subsequently routed into a primary light fluid chamber 122 positioned downstream of primary cyclonic separators 106 of the first separation stage. In some embodiments, primary light fluid chamber 122 may also serve as a secondary separator inlet 108 for a second separation stage. The second separation stage may include one or more secondary cyclonic separators 106 positioned downstream of primary cyclonic separators 106. In some embodiments, secondary cyclonic separators 106 may be horizontally displaced from one another within assembly 100. Separated light fluid 117 received by secondary separator inlet 108 may be routed into separation chambers 110 of each of the secondary cyclonic separators 106. Secondary cyclonic separators 106 may perform further separation on separated light fluid 117, thereby enhancing overall separation efficiency of assembly 100. Further, any heavy fluid separated from the light fluid during the second separation stage may be directed into a secondary heavy chamber inlet 118 of each of the secondary cyclonic separators 106. Separated heavy fluid 119 may then be routed to a secondary heavy fluid chamber 120 and a secondary heavy fluid chamber outlet 124. In some embodiments, the first separation stage or any subsequent separation stage may comprise a single cyclonic separator 106.

In some embodiments, any or all of the cyclonic separators 106, whether in the first separation stage or any subsequent separation stage, may be in fluid communication with a recycle chamber 126. The recycle chamber 126 may be configured to route re-cycled portion of light fluid 123 from heavy fluid chamber 120 to separation chambers 110 to reintroduce light fluid into one or more of the separation stages. Those skilled in the art will recognize that various configurations and flow path arrangements may be employed to implement multi-stage separation systems in accordance with embodiments disclosed herein, including series staging configurations and parallel staging configurations, variable inlet and outlet placements, and interconnections with recycle chamber 126, without departing from the scope of the invention.

FIG. 2 illustrates a cross-sectional view of an exemplary multi-cyclonic separator assembly 200 in accordance with embodiments disclosed herein. Assembly 200 may include, but is not limited to, all similar aspects and features of assembly 100 disclosed above in reference to FIG. 1.

In some embodiments, assembly 200 may include a single re-cycle system in fluid communication with at least one separation chamber 110 of the plurality of cyclonic separators 106. For example, assembly 200 may include two cyclonic separators 106 in fluid communication with a single re-cycle chamber 126 for re-cycling any re-cycled portion of light fluid 123 not yet received by light fluid chamber inlet 116 of either of the two cyclonic separators 106. For instance, any re-cycled portions of light fluid 123 located in heavy fluid chamber 120 may be re-cycled via re-cycle chamber 126 and re-enter at least one separation chamber 110 of either of the two cyclonic separators 106 of assembly 200.

In some embodiments, assembly 200 may include an intermediate re-cycle area 136 configured to hold re-cycled portion of light fluid 123 before re-entering separation chamber 110. Further re-cycle outlet channel 132 may be directly connected to separation chamber 110 or may extend partially into a top portion of separation chamber 110. Re-cycled portion of light fluid 123 may be routed through re-cycle outlet channel 132 to re-enter separation chamber 110 from intermediate re-cycle area 136 for further separation.

In some embodiments, as depicted in FIG. 2, swirl element 112 may be a tangential inlet structured to direct input stream 104 tangentially along the inner wall of separation chamber 110, thereby generating a downward rotating flow 114 that facilitates centrifugal separation of input stream 104. In some embodiments, swirl element 112 may include a plurality of tangential inlets distributed circumferentially around a housing of swirl element 112 to enhance the resulting swirling motion of downward rotating flow 114. For example, each tangential inlet may be oriented at an angle optimized to maintain the rotational velocity of input stream 104 within separation chamber 110. In some embodiments, swirl element 112 may include a nozzle (e.g., tube) in addition to a tangential inlet, positioned within or coupled to the housing of swirl element 112. The nozzle may be configured to introduce an additional flow stream (e.g., re-cycled portion of light fluid 123) into separation chamber 110.

The tangential inlet may be perpendicular or substantially perpendicular to separation chamber 110 such that, as input stream 104 is received by separation chamber 110, downward rotating flow 114 is induced within separation chamber 110. In some embodiments, downward rotating flow 114 may be induced by the tangential inlet without using a separate fluid rotation device located below or connected to the tangential inlet. In some embodiments, cyclonic separator 106 of assembly 100 may include a tangential inlet and a fluid rotation device, where the fluid rotation device is configured to assist the tangential inlet in inducing downward rotating flow 114 of input stream 104 inside separation chamber 110.

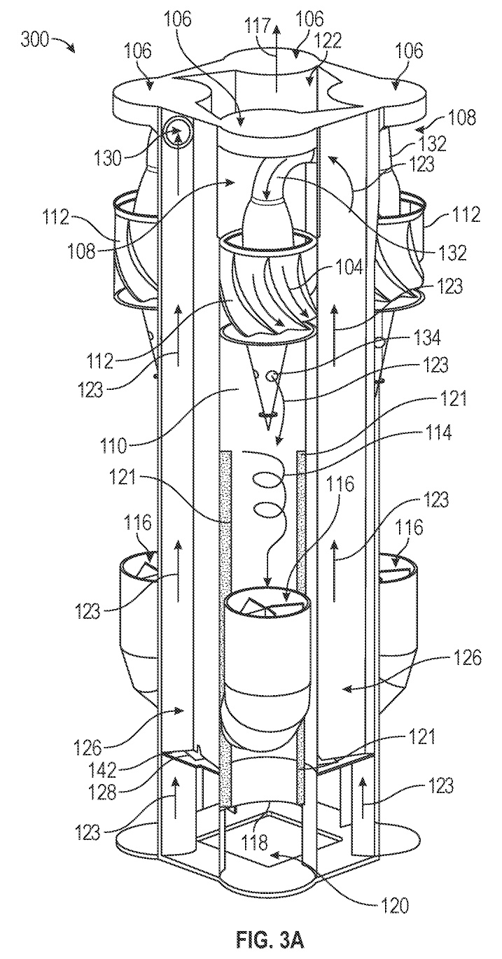

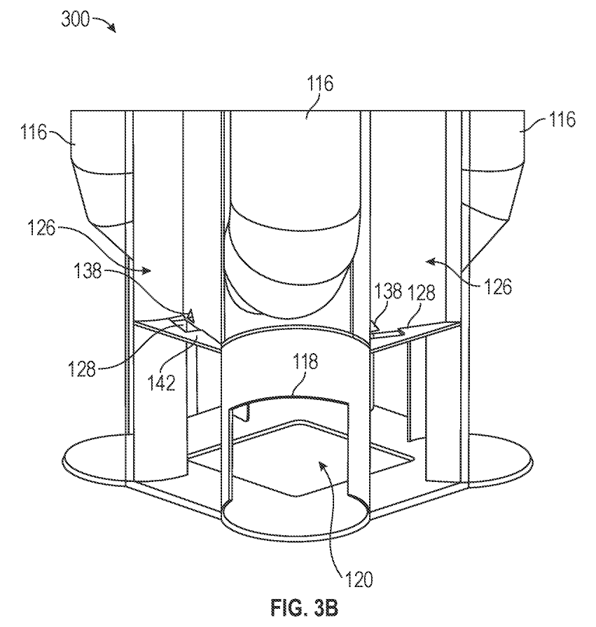

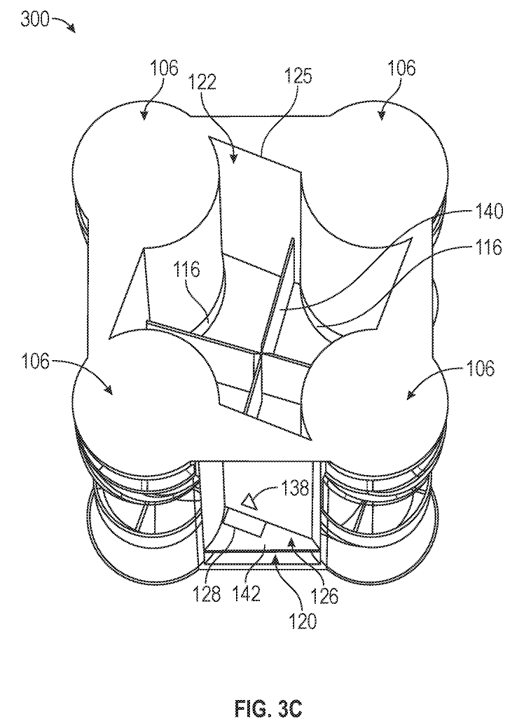

FIG. 3A illustrates a three-dimensional cutaway view of an exemplary multi-cyclonic separator assembly 300 in accordance with embodiments disclosed herein. The cutaway portions in FIG. 3A include the outer walls of separation chamber 110, the outer walls of recycle chamber 126, and the outer walls of heavy fluid chamber 120. Assembly 300 may include, but is not limited to, all similar aspects and features of assembly 100 and assembly 200 disclosed above in reference to FIGS. 1-2. In some embodiments, light fluid chamber 122 may be formed from the outer walls of cyclonic separators 106. For example, assembly 300 may include four cyclonic separators 106, where the walls of light fluid chamber 122 share the walls with the four cyclonic separators 106 (e.g., forming a centralized light fluid chamber 122). In some embodiments, cyclonic separators 106 may include separator walls coupled via interconnecting plates. The separator walls may be the portion of cyclonic separator 106 that partially or fully encloses an inner region of separation chamber 110.

In some embodiments, heavy fluid chamber inlet 118 is an opening, slot, tube, or channel located in a wall portion of separation chamber 110. For example, heavy fluid chamber inlet 118 may be a slot in a wall of separation chamber 110 located below light fluid chamber inlet 116. For instance, the heavy fluid contained in liquid film 121 may flow to the slot and enter heavy fluid chamber 120. In some embodiments, the light fluid not yet received by light fluid chamber inlet 116 may flow past light fluid chamber inlet 116 and into heavy fluid chamber 120 to become re-cycled portions of light fluid 123. In some embodiments, re-cycled portions of light fluid 123 may re-enter separation chamber 110 via re-cycle chamber 126. For example, re-cycled portion of light fluid 123 may flow from heavy fluid chamber 120 into re-cycle chamber 126 via re-cycle chamber inlet 128 and subsequently enter separation chamber 110 via re-cycle chamber outlet 130 for further separation. As discussed above in reference to FIG. 1, swirl element 112 may include fluid rotation device opening 134, where re-cycled portion of light fluid 123 re-enters separation chamber 110 via re-cycle outlet channel 132 and fluid rotation device opening 134.

In some embodiments, re-cycle chamber inlet 128 may be a slot or opening located in a bottom portion of re-cycle chamber 126. For example, re-cycle chamber 126 may include a plate 142 including re-cycle chamber inlet 128. In some embodiments, plate 142 forms a bottom end of re-cycle chamber 126. In some embodiments, re-cycle chamber outlet 130 may be a slot or opening located in a wall portion of re-cycle chamber 126.

FIG. 3B illustrates a three-dimensional cutaway view of a bottom portion of multi-cyclonic separator assembly 300 in accordance with embodiments disclosed herein. The cutaway portions in FIG. 3B include the outer walls of separation chamber 110, the outer walls of recycle chamber 126, and the outer walls of heavy fluid chamber 120. In some embodiments, at least one cyclonic separator 106 contained in assembly 300 may include a weep hole 138. Weep hole 138 may be an opening, channel, or slot that puts light fluid chamber 122 in fluid communication with re-cycle chamber 126. For example, weep hole 138 may be an opening in a shared wall of re-cycle chamber 126 and light fluid chamber 122. In some embodiments, weep hole 138 may be continuously connected to re-cycle chamber inlet 128. For example, weep hole 138 may be on a wall portion of re-cycle chamber 126 and continuously connected to re-cycle chamber inlet 128 located on plate 142 to form a continuous opening. Weep hole 138 is configured to allow the heavy fluid located in light fluid chamber 122, which has not yet been received by heavy fluid chamber inlet 118, to enter heavy fluid chamber 120. For example, as the heavy fluid travels through separation chamber 110, a portion of the heavy fluid 119 may be positioned within downward rotating flow 114 such that the portion of the heavy fluid enters light fluid chamber inlet 116. For instance, if the flow speed of downward rotating flow 114 is too high, the heavy fluid particles contained in liquid film 121 may be stripped and re-enter a central region of downward rotating flow 114 such that the re-entered heavy fluid particles enter light fluid chamber 122 via light fluid chamber inlet 116. Weep hole 138 allows any portion of the heavy fluid located in light fluid chamber 122 to flow out of light fluid chamber 122 and enter heavy fluid chamber 120. Moving the heavy fluid from light fluid chamber 122 to heavy fluid chamber 120 may be assisted by a high to low-pressure gradient flowing from light fluid chamber 122 to weep hole 138, to re-cycle chamber inlet 128, and then to heavy fluid chamber 120. For example, while assembly 300 is in operation, the pressure may be lower in re-cycle chamber 126 than light fluid chamber 122. This pressure gradient also prevents any portion of the heavy fluid entering re-cycle chamber 126 from entering light fluid chamber 122 through weep hole 138 during operation.

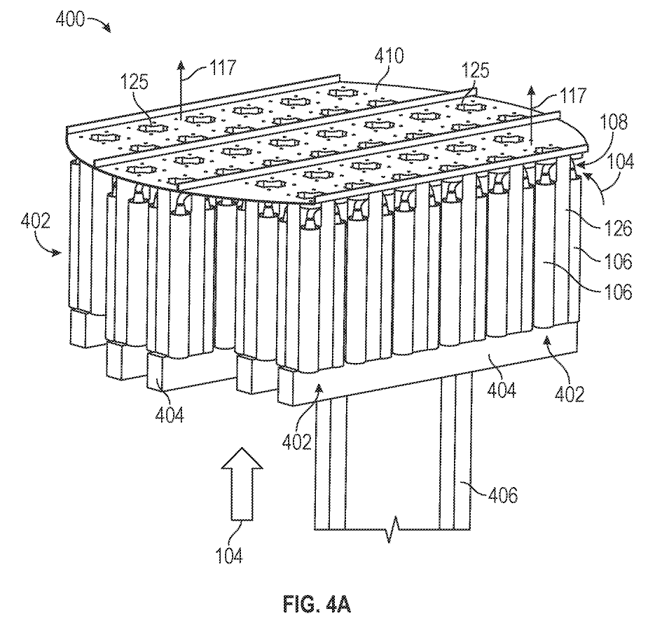

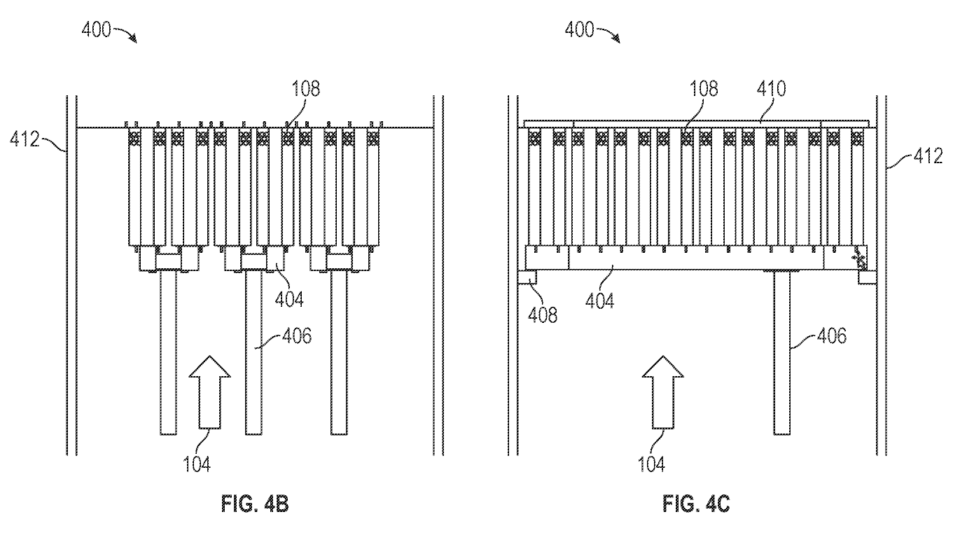

In some embodiments, weep hole 138 may act as a safety feature for a system of multi-cyclonic separator assemblies (see system 400 described below in reference to FIGS. 4A-4C) contained within a separator vessel. For example, multiple cyclonic separator assembly 300 may be disposed within the separator vessel, which may be accessible by operators of assembly 300. During start-up, shut down, or if temperature changes occur during shut down of the system, there may be no gas flow within the separator vessel, but condensation may still occur. Thus, weep hole 138 may be used as a safety feature to ensure that when the separator vessel is shut down (e.g., for maintenance), the separator vessel may be drained of any heavy fluid so that there are no pools of the heavy fluid releasing toxic fumes that may be harmful to any personnel entering the separator vessel.

FIG. 3C illustrates a three-dimensional cutaway view of multi-cyclonic separator assembly 300 in accordance with embodiments disclosed herein. The cutaway portions in FIG. 3C include the outer walls of separation chamber 110, the outer walls of recycle chamber 126, and the outer walls of heavy fluid chamber 120. In some embodiments, assembly 300 may further include an anti-rotation baffle 140 configured for managing a pressure drop within light fluid chamber 122. For example, assembly 300 may be designed so that two or more light fluid chamber inlets 116 oppose each other, where the momentum of any separated light fluid 117 entering light fluid chamber 122 through opposing light fluid chamber inlets 116 flows towards a center region of light fluid chamber 122. To prevent separated light fluid 117 from rotating within light fluid chamber 122 and maintaining a lower pressure within light fluid chamber 122, separated light fluid 117 may hit a wall portion of anti-rotation baffle 140 to induce a stagnation pressure. The stagnation pressure may create a pressure drop in light fluid chamber 122 that assists in directing any heavy fluid contained within light fluid chamber 122 toward and through weep hole 138 and into heavy fluid chamber 120. In some embodiments, anti-rotation baffle 140 may be in a cross-shaped baffle consisting of four intersecting walls forming a cross shape. In other embodiments, anti-rotation baffle 140 may be a three-walled baffle, two-walled baffle, or a single-wall baffle configured for deflecting, absorbing, or directing the flow of separated light fluid 117 entering light fluid chamber 122. In some embodiments, as depicted in FIG. 3C, assembly 300 may include four cyclonic separators 106, forming a clover-like assembly structure.

As discussed in FIG. 1 above, it is noted herein that multi-cyclonic separator assemblies 200 and 300 described above may also include two or more separation stages to increase separation efficiency. Multi-cyclonic separator assemblies 200 and 300, which disclose alternative configurations to multi-cyclonic separator assembly 100 of cyclonic separators within a multi-cyclonic separator assembly, such as differing in the arrangement of light fluid and heavy fluid outlets, may also comprise one or more separation stages downstream from a primary separation stage. In such embodiments, each separation stage may include components and flow paths consistent with the specific structural features disclosed for the respective assembly. The separation stages within each assembly may be configured to optimize separation based on the orientation, outlet positioning, and internal flow dynamics particular to that embodiment.

FIGS. 4A-4C generally illustrate an exemplary system of multi-cyclonic separator assemblies in accordance with embodiments disclosed herein. For example, system 400 may include one or more multi-cyclonic separator assemblies 402. In some embodiments, a multi-cyclonic separator assembly 402 may be, but is not limited to, assembly 100, assembly 200, or assembly 300 described above in reference to FIGS. 1 through 3C.

In some embodiments, system 400 may include a drain system. The drain system may include one or more drain troughs 404 and one or more drain headers 406. Drain troughs 404 may be in fluid communication with each heavy fluid chamber outlet 124 of the multi-cyclonic separator assemblies 402 and configured to receive a portion of separated heavy fluid 119 from each heavy fluid chamber outlet 124. In some embodiments, a single drain trough 404 may be coupled to any number of multi-cyclonic separator assemblies 402. In some embodiments, drain troughs 404 may be directly coupled (e.g., attached or bolted) to multi-cyclonic separator assemblies 402 rather than requiring additional components, such as additional drain channels, for connecting the drain header 406 to multi-cyclonic separator assembly 402. In some embodiments, drain troughs 404 may be configured as a downcomer for guiding separated heavy fluid 119 from a higher to a lower elevation (e.g., ground level).

In some embodiments, drain troughs 404 may be in fluid communication with drain headers 406 and configured to receive the portion of separated heavy fluid 119 from drain troughs 404. Each drain header 406 in system 400 may be coupled to any number of drain troughs 404. In some embodiments, a central drain header 406 may be coupled to drain troughs 404 of system 400.

Directly coupling the drain system to multi-cyclonic separator assemblies 402 advantageously allows system 400 to maximize drain capacity and prevent drain troughs 404 and/or multi-cyclonic separator assemblies 402 from overfilling and exceeding a drain capacity limit. Maximizing drain capacity of system 400 helps avoid a decrease in separation efficiency for multi-cyclonic separator assemblies 402. For example, maximizing drain capacity may prevent heavy fluid chamber 120 from overfilling, where separated heavy fluid 119 may otherwise be forced and pushed upwards to enter a re-cycle chamber 126 and/or light fluid chamber 122 of a cyclonic separator 106. Additionally, where separator inlets 108 are not located on a bottom surface of a respective multi-cyclonic separator assembly 402 (e.g., the same surface that drain troughs 404 may be coupled to), multi-cyclonic separator assemblies 402 may handle an increased capacity of liquid since less liquid may pool in a respective heavy fluid chamber 120.

In some embodiments, system 400 may include one or more supports 408, a mounting surface 410, and/or a vessel wall 412. In some embodiments, supports 408 may be coupled to vessel wall 412. For example, system 400 may be disposed within a separator vessel (e.g., accessible by operators), where the separator vessel includes vessel wall 412. Vessel wall 412 may partially or fully enclose system 400. In some embodiments, drain headers 406 may be coupled to supports 408 for stabilizing and managing a load of system 400. For example, attaching drain troughs 404 to supports 408 may reduce the load of multi-cyclonic separator assemblies 402 on mounting surface 410. Mounting surface 410 may provide a mounting surface for multi-cyclonic separator assemblies 402 to ensure that input stream 104 passes through the multi-cyclonic separator assemblies 402. For example, input stream 104 may travel upward from the bottom of the separator vessel and enter separator inlets 108 of each multi-cyclonic separator assembly 402 of system 400. Subsequently, separated light fluid 117 may exit a respective multi-cyclonic separator assembly 402 via light fluid chamber outlets 125 located on a top side of mounting surface 410. In some embodiments, mounting surface 410 is a deck (e.g., cyclone deck) configured to provide structural support for multi-cyclonic separator assemblies 402 inside the separator vessel.

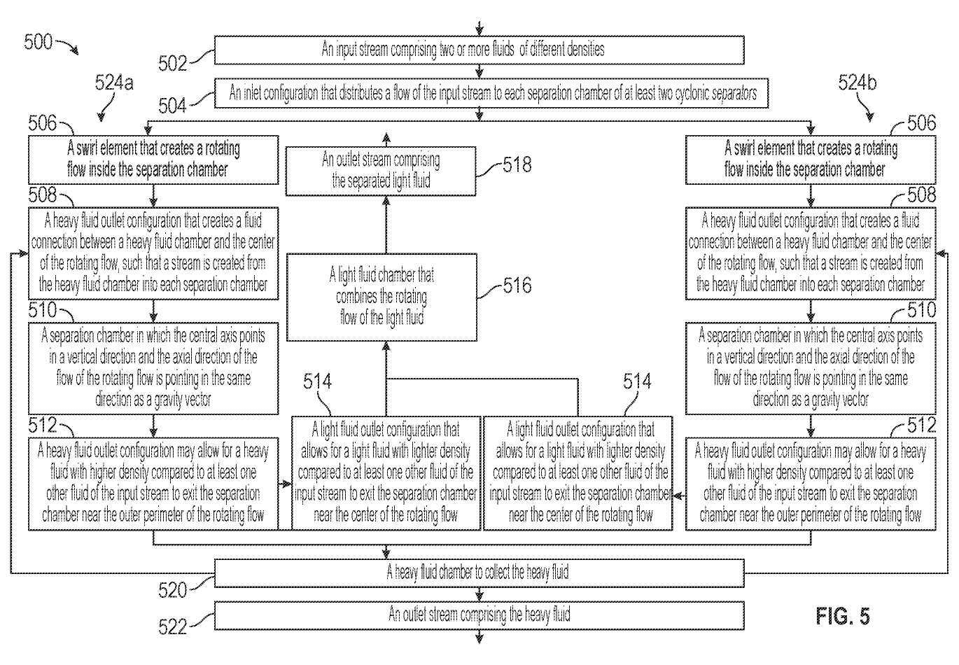

FIG. 5 illustrates an exemplary multi-cyclonic separator assembly configuration 500 in accordance with embodiments disclosed herein. Configuration 500 may include all similar features and aspects of assembly 100, assembly 200, or assembly 300 described above in reference to FIGS. 1-3C.

At component 502, configuration 500 may include an input stream comprising two or more fluids of different densities. For example, the input stream may comprise a heavy fluid and/or a light fluid, where the heavy fluid is denser than the light fluid. For example, the input stream may comprise a first liquid and a second liquid, where the second liquid is denser than the first liquid. In another example, the input stream may comprise a liquid and a gas, where the liquid is denser than the gas. In even another example, the input stream may comprise a first gas and a second gas, where the second gas is denser than the first gas.

At component 504, configuration 500 may include an inlet configuration that distributes a flow of the input stream to each separation chamber of at least two cyclonic separators 524a, 524b. The at least two cyclonic separators 524a, 524b may each include the components and configurations in components 506 through 514 discussed below. In some embodiments, configuration 500 includes a single cyclonic separator. For example, configuration 500 may include a cyclonic separator 524a, where the inlet configuration distributes a flow of the input stream to the separation chamber of the single cyclonic separator 524a. The single cyclonic separator may include the components and configurations disclosed in components 506 through 514. In other embodiments, configuration 500 may include any number of cyclonic separators including the components and configurations in components 506 through 514.

At component 506, each cyclonic separator of configuration 500 may include a swirl element that creates a rotating flow inside the separation chamber such that centrifugal forces are generated to separate fluids within the input stream based on a density difference between the fluids. In some embodiments, the swirl element may be a tangential inlet or a fluid rotation device (see discussion of swirl element 112 in reference to FIGS. 1-3A above).

At component 508, each cyclonic separator of configuration 500 may include a heavy fluid outlet configuration that creates a fluid connection between a heavy fluid chamber and the center of the rotating flow, such that a stream is created from the heavy fluid chamber into each separation chamber. In some embodiments, one heavy fluid chamber may be in fluid communication with all of the separation chambers contained in configuration 500. In some embodiments, a re-cycle system is the fluid connection between the heavy fluid chamber and the center of the rotating flow,

At component 510, each cyclonic separator of configuration 500 may include a separation chamber in which the central axis points in a vertical direction and the axial direction of the flow of the rotating flow is pointing in the same direction as a gravity vector.

At component 512, the heavy fluid outlet configuration of each cyclonic separator of configuration 500 may allow for a heavy fluid with a higher density compared to at least one other fluid of the input stream to exit the separation chamber near the outer perimeter of the rotating flow. For example, the heavy fluid outlet configuration may be a chamber, tube, channel, slot or any other suitable structure configured to receive and direct the flow of heavy fluid to exit the separation chamber near the outer perimeter of the rotating flow.

At component 514, each cyclonic separator of configuration 500 may include a light fluid outlet configuration that allows for a light fluid with a lighter density compared to at least one other fluid of the input stream to exit the separation chamber near the center of the rotating flow. For example, the light fluid outlet configuration may be a chamber, tube, channel, or other suitable structure configured to receive and direct the flow of light fluid to exit the separation chamber near the center of the rotating flow. In some embodiments, the opening of the light fluid configuration is in a central or substantially central region within the separation chamber such that particles of the light fluid may enter light fluid outlet configuration for separation.

At component 516, configuration 500 may include a light fluid chamber that combines the rotating flow of the light fluid. For example, the light fluid chamber may be configured to receive light fluid from the light fluid outlet configuration of each cyclonic separator of configuration 500.

At component 518, configuration 500 may include an outlet stream comprising the separated light fluid. For example, the outlet stream comprising the separated light fluid may exit configuration 500 through a light fluid chamber outlet such as a channel, drain, chamber, or tube. In some embodiments, the fluid chamber outlet may be in fluid communication with downstream processing or discharge systems.

At component 520, configuration 500 may include a heavy fluid chamber to collect the heavy fluid. For example, the heavy fluid chamber may be configured to receive separated heavy fluid from the heavy fluid outlet configuration of each cyclonic separator of configuration 500. In some embodiments, configuration 500 may further include a re-cycle system in fluid communication with the heavy fluid chamber and at least one separation chamber of the at least two cyclonic separators 524a, 524b. The re-cycle systems may be used to increase separation efficiency of each cyclonic separator of configuration 500 by directing a flow of light fluid portions contained within the heavy fluid chamber to re-enter separation chamber for further separation. For instance, light fluid portions contained within the heavy fluid chamber may flow through a re-cycle chamber and into at least one separation chamber of configuration 500. In some embodiments, the re-cycle chamber is the created stream of component 508 discussed above, where the light fluid portions flow from the heavy fluid chamber into each separation chamber.

At component 522, configuration may include an outlet stream comprising the heavy fluid. For example, the outlet stream comprising the heavy fluid may exit configuration 500 through a heavy fluid chamber outlet such as a channel, drain, chamber, or tube.

The following embodiments represent exemplary embodiments of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting.

Clause 1. A cyclonic separator, comprising: an inlet configured to receive an input stream, wherein the input stream comprises a heavy fluid and a light fluid; a separation chamber in fluid communication with the inlet, comprising: a swirl element configured to induce a downward rotating flow of the input stream inside the separation chamber such that centrifugal forces are generated to at least partially separate the heavy fluid from the light fluid; a light fluid chamber inlet configured to receive the separated light fluid; and a heavy fluid chamber inlet configured to receive the separated heavy fluid; and a light fluid chamber in fluid communication with the light fluid chamber inlet of the cyclonic separator, wherein the light fluid chamber is configured to receive the separated light fluid from the separation chamber; a heavy fluid chamber in fluid communication with the heavy fluid chamber inlet of the separation chamber, wherein the heavy fluid chamber is configured to receive the separated heavy fluid from the separation chamber; and a heavy fluid chamber outlet in fluid communication with the heavy fluid chamber, wherein the heavy fluid chamber outlet is configured to receive the separated heavy fluid from the heavy fluid chamber.

Clause 2. The cyclonic separator of clause 1, wherein the cyclonic separator further comprises: a re-cycle chamber in fluid communication with the heavy fluid chamber and the separation chamber of the cyclonic separator, wherein the re-cycle chamber is configured to route a re-cycled portion of the light fluid from the heavy fluid chamber to the separation chamber of the cyclonic separator.

Clause 3. The cyclonic separator of any of clauses 1 or 2, wherein the re-cycle chamber comprises: a re-cycle outlet channel coupled to the swirl element, wherein the swirl element is a fluid rotation device, the fluid rotation device comprising: at least one fluid rotation device opening in fluid communication with the re-cycle outlet channel, wherein the re-cycled portion of the light fluid is routed from the heavy fluid chamber to the separation chamber of the cyclonic separator via the re-cycle outlet channel and the at least one fluid rotation device opening.

Clause 4. The cyclonic separator of any of clauses 1 through 3, wherein the re-cycle chamber further comprises: a weep hole configured to put the light fluid chamber in fluid communication with the re-cycle chamber.

Clause 5. The cyclonic separator of any of clauses 1 through 4, wherein at least a first portion of a wall of the separation chamber shares a portion of a wall of the re-cycle chamber, wherein at least a portion of a wall of the light fluid chamber shares a second portion of the wall of the separation chamber.

Clause 6. The cyclonic separator of any of clauses 1 through 5, wherein the light fluid chamber comprises: an anti-rotation baffle configured to assist in managing a pressure drop within the light fluid chamber of the cyclonic separator.

Clause 7. The cyclonic separator of any of clauses 1 through 6, wherein the heavy fluid chamber inlet is a slot in a wall of the separation chamber, wherein the slot is located below the light fluid chamber inlet.

Clause 8. The cyclonic separator of any of clauses 1 through 7, wherein a first end of the light fluid chamber inlet is located within a central region of the separation chamber.

Clause 9. The cyclonic separator of any of clauses 1 through 8, wherein the swirl element is a tangential inlet.

Clause 10. The cyclonic separator of any of clauses 1 through 9, wherein the input stream enters the inlet at a location above the swirl element.

Clause 11. A multi-cyclonic separator assembly, comprising: a plurality of cyclonic separators, wherein each cyclonic separator of the plurality of cyclonic separators comprises: at least one tangential inlet configured to receive an input stream, wherein the input stream comprises a heavy fluid and a light fluid; and a separation chamber in fluid communication with the at least one tangential inlet, wherein the at least one tangential inlet is further configured to induce a downward rotating flow of the input stream inside the separation chamber such that centrifugal forces are generated to at least partially separate the heavy fluid from the light fluid, wherein the separation chamber comprises: a light fluid chamber inlet configured to receive the separated light fluid; and a heavy fluid chamber inlet configured to receive the separated heavy fluid; and a light fluid chamber in fluid communication with each light fluid chamber inlet of the plurality of cyclonic separators, wherein the light fluid chamber is configured to receive the separated light fluid from each cyclonic separator of the plurality of cyclonic separators; a heavy fluid chamber in fluid communication with each heavy fluid chamber inlet of the plurality of cyclonic separators, wherein the heavy fluid chamber is configured to receive the separated heavy fluid from each cyclonic separator of the plurality of cyclonic separators; and a heavy fluid chamber outlet in fluid communication with the heavy fluid chamber, wherein the heavy fluid chamber outlet is configured to receive the separated heavy fluid from the heavy fluid chamber.

Clause 12. The multi-cyclonic separator assembly of clause 11, wherein the multi-cyclonic separator assembly further comprises: a re-cycle chamber in fluid communication with the heavy fluid chamber and at least one separation chamber of the plurality of cyclonic separators, wherein the re-cycle chamber is configured to route a re-cycled portion of the light fluid from the heavy fluid chamber to the at least one separation chamber.

Clause 13. The multi-cyclonic separator assembly of any of clauses 11 or 12, wherein at least a portion of a wall of the separation chamber shares a portion of a wall of the re-cycle chamber.

Clause 14. The multi-cyclonic separator assembly of any of clauses 11 through 13, wherein the separation chamber further comprises: a fluid rotation device configured to assist the at least one tangential inlet in inducing the downward rotating flow of the input stream inside the separation chamber.

Clause 15. The multi-cyclonic separator assembly of any of clauses 11 through 14, further comprising: a drain trough in fluid communication with the heavy fluid chamber outlet and configured to receive the separated heavy fluid from the heavy fluid chamber outlet.

Clause 16. The multi-cyclonic separator assembly of any of clauses 11 through 15, further comprising: a drain header in fluid communication with the drain trough and configured to receive the separated heavy fluid from the drain trough.

Clause 17. A system of multi-cyclonic separator assemblies, comprising: a plurality of multi-cyclonic separator assemblies, wherein each multi-cyclonic separator assembly of the plurality of multi-cyclonic separator assemblies comprises: a plurality of cyclonic separators, wherein each cyclonic separator of the plurality of cyclonic separators comprises: a swirl element configured to receive an input stream, wherein the input stream comprises a heavy fluid and a light fluid; and a separation chamber in fluid communication with the swirl element, wherein the swirl element is further configured to induce a downward rotating flow of the input stream inside the separation chamber such that centrifugal forces are generated to at least partially separate the heavy fluid from the light fluid, wherein the separation chamber comprises: a light fluid chamber inlet configured to receive the separated light fluid; and a heavy fluid chamber inlet configured to receive the separated heavy fluid; and a light fluid chamber in fluid communication with each light fluid chamber inlet of the plurality of cyclonic separators, wherein the light fluid chamber is configured to receive the separated light fluid from each cyclonic separator of the plurality of cyclonic separators; a heavy fluid chamber in fluid communication with each heavy fluid chamber inlet of the plurality of cyclonic separators, wherein the heavy fluid chamber is configured to receive the separated heavy fluid from each cyclonic separator of the plurality of cyclonic separators; and a heavy fluid chamber outlet in fluid communication with the heavy fluid chamber, wherein the heavy fluid chamber outlet is configured to receive the separated heavy fluid from the heavy fluid chamber.

Clause 18. The system of multi-cyclonic separator assemblies of clause 17, further comprising: a drain trough in fluid communication with the plurality of multi-cyclonic separator assemblies and configured to receive the separated heavy fluid from each multi-cyclonic separator assembly of the plurality of multi-cyclonic separator assemblies.

Clause 19. The system of multi-cyclonic separator assemblies of any of clauses 17 or 18, further comprising: a drain header in fluid communication with the drain trough and configured to receive the separated heavy fluid from the drain trough.

Clause 20. The system of multi-cyclonic separator assemblies of any of clauses 17 through 19, wherein two or more cyclonic separators of the plurality of cyclonic separators are arranged in at least one of a series staging configuration or a parallel staging configuration.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. A cyclonic separator, comprising:
an inlet configured to receive an input stream, wherein the input stream comprises a heavy fluid and a light fluid;
a separation chamber in fluid communication with the inlet, comprising:
a swirl element configured to induce a downward rotating flow of the input stream inside the separation chamber such that centrifugal forces are generated to at least partially separate the heavy fluid from the light fluid;
a light fluid chamber inlet configured to receive the separated light fluid; and
a heavy fluid chamber inlet configured to receive the separated heavy fluid; and
a light fluid chamber in fluid communication with the light fluid chamber inlet of the cyclonic separator, wherein the light fluid chamber is configured to receive the separated light fluid from the separation chamber;
a heavy fluid chamber in fluid communication with the heavy fluid chamber inlet of the separation chamber, wherein the heavy fluid chamber is configured to receive the separated heavy fluid from the separation chamber; and
a heavy fluid chamber outlet in fluid communication with the heavy fluid chamber, wherein the heavy fluid chamber outlet is configured to receive the separated heavy fluid from the heavy fluid chamber.

2. The cyclonic separator of claim 1, wherein the cyclonic separator further comprises:
a re-cycle chamber in fluid communication with the heavy fluid chamber and the separation chamber of the cyclonic separator,
wherein the re-cycle chamber is configured to route a re-cycled portion of the light fluid from the heavy fluid chamber to the separation chamber of the cyclonic separator.

3. The cyclonic separator of claim 2, wherein the re-cycle chamber comprises:
a re-cycle outlet channel coupled to the swirl element, wherein the swirl element is a fluid rotation device, the fluid rotation device comprising:
at least one fluid rotation device opening in fluid communication with the re-cycle outlet channel, wherein the re-cycled portion of the light fluid is routed from the heavy fluid chamber to the separation chamber of the cyclonic separator via the re-cycle outlet channel and the at least one fluid rotation device opening.

4. The cyclonic separator of claim 2, wherein the re-cycle chamber further comprises:
a weep hole configured to put the light fluid chamber in fluid communication with the re-cycle chamber.

5. The cyclonic separator of claim 2, wherein at least a first portion of a wall of the separation chamber shares a portion of a wall of the re-cycle chamber, wherein at least a portion of a wall of the light fluid chamber shares a second portion of the wall of the separation chamber.

6. The cyclonic separator of claim 1, wherein the light fluid chamber comprises:
an anti-rotation baffle configured to assist in managing a pressure drop within the light fluid chamber of the cyclonic separator.

7. The cyclonic separator of claim 1, wherein the heavy fluid chamber inlet is a slot in a wall of the separation chamber, wherein the slot is located below the light fluid chamber inlet.

8. The cyclonic separator of claim 1, wherein a first end of the light fluid chamber inlet is located within a central region of the separation chamber.

9. The cyclonic separator of claim 1, wherein the swirl element is a tangential inlet.

10. The cyclonic separator of claim 1, wherein the input stream enters the inlet at a location above the swirl element.

11. A multi-cyclonic separator assembly, comprising:
a plurality of cyclonic separators, wherein each cyclonic separator of the plurality of cyclonic separators comprises:
at least one tangential inlet configured to receive an input stream, wherein the input stream comprises a heavy fluid and a light fluid; and
a separation chamber in fluid communication with the at least one tangential inlet, wherein the at least one tangential inlet is further configured to induce a downward rotating flow of the input stream inside the separation chamber such that centrifugal forces are generated to at least partially separate the heavy fluid from the light fluid, wherein the separation chamber comprises:
a light fluid chamber inlet configured to receive the separated light fluid; and
a heavy fluid chamber inlet configured to receive the separated heavy fluid; and
a light fluid chamber in fluid communication with each light fluid chamber inlet of the plurality of cyclonic separators, wherein the light fluid chamber is configured to receive the separated light fluid from each cyclonic separator of the plurality of cyclonic separators;
a heavy fluid chamber in fluid communication with each heavy fluid chamber inlet of the plurality of cyclonic separators, wherein the heavy fluid chamber is configured to receive the separated heavy fluid from each cyclonic separator of the plurality of cyclonic separators; and
a heavy fluid chamber outlet in fluid communication with the heavy fluid chamber, wherein the heavy fluid chamber outlet is configured to receive the separated heavy fluid from the heavy fluid chamber.

12. The multi-cyclonic separator assembly of claim 11, wherein the multi-cyclonic separator assembly further comprises:
a re-cycle chamber in fluid communication with the heavy fluid chamber and at least one separation chamber of the plurality of cyclonic separators,
wherein the re-cycle chamber is configured to route a re-cycled portion of the light fluid from the heavy fluid chamber to the at least one separation chamber.

13. The multi-cyclonic separator assembly of claim 12, wherein at least a portion of a wall of the separation chamber shares a portion of a wall of the re-cycle chamber.

14. The multi-cyclonic separator assembly of claim 12, wherein the separation chamber further comprises:
a fluid rotation device configured to assist the at least one tangential inlet in inducing the downward rotating flow of the input stream inside the separation chamber.

15. The multi-cyclonic separator assembly of claim 12, further comprising:
a drain trough in fluid communication with the heavy fluid chamber outlet and configured to receive the separated heavy fluid from the heavy fluid chamber outlet.

16. The multi-cyclonic separator assembly of claim 15, further comprising:
a drain header in fluid communication with the drain trough and configured to receive the separated heavy fluid from the drain trough.

17. A system of multi-cyclonic separator assemblies, comprising:
a plurality of multi-cyclonic separator assemblies, wherein each multi-cyclonic separator assembly of the plurality of multi-cyclonic separator assemblies comprises:
a plurality of cyclonic separators, wherein each cyclonic separator of the plurality of cyclonic separators comprises:
a swirl element configured to receive an input stream, wherein the input stream comprises a heavy fluid and a light fluid; and
a separation chamber in fluid communication with the swirl element, wherein the swirl element is further configured to induce a downward rotating flow of the input stream inside the separation chamber such that centrifugal forces are generated to at least partially separate the heavy fluid from the light fluid, wherein the separation chamber comprises:
a light fluid chamber inlet configured to receive the separated light fluid; and
a heavy fluid chamber inlet configured to receive the separated heavy fluid; and
a light fluid chamber in fluid communication with each light fluid chamber inlet of the plurality of cyclonic separators, wherein the light fluid chamber is configured to receive the separated light fluid from each cyclonic separator of the plurality of cyclonic separators;
a heavy fluid chamber in fluid communication with each heavy fluid chamber inlet of the plurality of cyclonic separators, wherein the heavy fluid chamber is configured to receive the separated heavy fluid from each cyclonic separator of the plurality of cyclonic separators; and
a heavy fluid chamber outlet in fluid communication with the heavy fluid chamber, wherein the heavy fluid chamber outlet is configured to receive the separated heavy fluid from the heavy fluid chamber.

18. The system of multi-cyclonic separator assemblies of claim 17, further comprising:
a drain trough in fluid communication with the plurality of multi-cyclonic separator assemblies and configured to receive the separated heavy fluid from each multi-cyclonic separator assembly of the plurality of multi-cyclonic separator assemblies.

19. The system of multi-cyclonic separator assemblies of claim 18, further comprising:
a drain header in fluid communication with the drain trough and configured to receive the separated heavy fluid from the drain trough.

20. The system of multi-cyclonic separator assemblies of claim 17, wherein two or more cyclonic separators of the plurality of cyclonic separators are arranged in at least one of a series staging configuration or a parallel staging configuration.
